(19) United States
(12) Patent Application Publication
(10) Pub. No.: US 2013/0222856 A1
(43) Pub. Date: Aug. 29, 2013

(54) TERMINAL APPARATUS FOR CONTROLLING ENCLOSING/SEALING SYSTEM AND RECORDING MEDIUM FOR RECORDING PROGRAM THEREFOR

(71) Applicant: RISO KAGAKU CORPORATION, (US)

(72) Inventors: Hideo NAKAO, Tokyo (JP); Takashi KUBO, Tokyo (JP); Kouichi NOBUSHIMA, Tokyo (JP)

(73) Assignee: RISO KAGAKU CORPORATION, TOKYO (JP)

(21) Appl. No.: 13/762,205

(22) Filed: Feb. 7, 2013

(30) Foreign Application Priority Data
Feb. 23, 2012 (JP) 2012-037936

(51) Int. Cl. G06F 3/12

(52) U.S. Cl. CPC G06F 3/1243
USPC 358/1.18

(57) ABSTRACT

A terminal apparatus controlling an enclosing/sealing system, wherein a document application successively generates, for each mail, document data of at least one mails. An envelope data generation unit generates envelope page data including a destination based on destination information corresponding to the document data for each mail. A separation detection unit detects separation data that represents separation for each mail arranged at a prescribed position in the document data. A sorting unit sorts the document data of one or a plurality of mails for each mail in according to the separation data. A print job generation unit associates each piece of document data sorted by the sorting unit for each mail with each piece of envelope page data for each mail generated by the envelope page data generation unit, and generates a print job of one or a plurality of successive mails for each mail.

### CROSS-REFERENCE TO RELATED APPLICATIONS

This application is based upon and claims the benefit of priority of the prior Japanese Application No. 2012-037936, filed on Feb. 23, 2012, the entire contents of which are incorporated herein by reference.

### FIELD

The present invention relates to a terminal apparatus for controlling an enclosing/sealing system that includes a printing apparatus for performing printing on an object to be enclosed and an envelope, and an enclosing/sealing apparatus for performing an enclosing/sealing process on a object to be enclosed and an envelope on which printing has been performed, and also to a recording medium for recording a program for such a apparatus.

### BACKGROUND

Conventionally, in an enclosing/sealing system having a printing apparatus and a enclosing/sealing apparatus, an enclosing/sealing apparatus is used for automating the process of enclosing a printed object to be enclosed in an envelope for the purpose of reducing labor, increasing efficiency, etc. Using an envelope having a window when contents and numbers of sheets to be enclosed and sealed by an enclosing/sealing apparatus vary in accordance with destination as in cases of invoices, shipping slips, credit card statements, bank account balance statements of banking facilities, and the like has been generally practiced. When an envelope with a window is used, an address or the like is not printed on it, but is printed at a prescribed position on a sheet to be enclosed so that printed information can be read through the window on the envelope after the enclosure and sealing.

Japanese Laid-open Patent Publication No. 2002-370718, for example, has disclosed a technique of an enclosing/sealing apparatus. According to the technique of the document, printing data is transmitted to a printing apparatus, and data on the number of sheets and envelope selection data, which is for selecting an associated envelope, are transmitted to the enclosing/sealing apparatus. The enclosing/sealing apparatus encloses printed sheets in the envelope selected on the basis of the envelope selection data, and seals the envelope. According to this configuration, enclosed objects varying in number in accordance with destination can be enclosed in envelopes with window, and the envelopes can be sealed.

According to the technique disclosed by Japanese Laid-open Patent Publication No. 2002-370718 above, printing is performed on objects to be enclosed in an envelope on the basis of printing data, whereas no printing is performed on envelopes. Also, there is form application software as an example of generating objects to be enclosed. According to Japanese Laid-open Patent Publication No. 2002-370718, when this form application software is used for performing an enclosing/sealing process, there is a problem as described below.

This form application software does not take into consideration printing information on envelopes even though it has the ability to successively generate document data that constitutes one or a plurality of transmission sets of enclosed objects, and accordingly it cannot generate envelope page data to be printed on envelopes, and also cannot associate the envelope page data with enclosed object data. Accordingly, users have to perform setting of associating enclosed object data and envelope page data, which has been troublesome.

As described above, it has conventionally been desired that when this existing form application software is to be used in an enclosing/sealing system having a printing apparatus capable of printing information on objects to be enclosed and on envelopes, and an enclosing/sealing apparatus, envelope page data can be generated by using another application software and enclosed object data generated by a form application software can be associated with the envelope page data. If this is realized, an existing form application software can be used, making it possible to reduce the cost of generating printing jobs for performing an enclosing/sealing process.

### SUMMARY

It is an object of the present invention to provide a technique that can realize at low cost the generation of printing jobs for associating enclosed object data generated by an existing document application with envelope page data and performing a printing process and an enclosing/sealing process.

In order to realize the above object, a first feature of the terminal apparatus according to the present invention is a terminal apparatus that controls an enclosing/sealing system including a printing apparatus for performing printing on an object to be enclosed and an envelope in accordance with a print job, and an enclosing/sealing apparatus for performing an enclosing/sealing process on the object to be enclosed and the envelope on which the printing apparatus has performed the printing, the terminal apparatus including an enclosed object data generation unit configured to successively generate, for each mail, enclosed object page data of one or a plurality of mails, an envelope page data generation unit configured to generate envelope page data including a destination on the basis of destination information associated, for each mail, with the envelope page data of one or a plurality of mails, a separation detection unit configured to detect separation data that represents separation for each mail arranged at a prescribed position in the enclosed object page data, a sorting unit configured to sort the enclosed object page data of one or a plurality of mails for each mail in accordance with the separation data detected by the separation detection unit, and a print job generation unit configured to associate each piece of page data sorted by the sorting unit for each mail with each piece of envelope page data for each mail generated by the envelope page data generation unit, and to generate a print job of one or a plurality of successive mails for each mail.

A second feature of the terminal apparatus according to the present invention is that the separation data is arranged at a top or a tail of each mail of the page data, and the printing job generation unit adds each piece of envelope page data to a top or a tail of the enclosed object page data of one or a plurality of mails sorted by the sorting unit for each mail so as to perform association for each mail, and generates the printing job of one or a plurality of mails.

A third feature of the terminal apparatus according to the present invention is that a destination information detection unit configured to detect destination information associated with each mail from the enclosed object page data of one or a plurality of mails is further included, and the envelope page data generation unit generates the envelope page data by using prescribed envelope form data and the destination information detected by the destination information detection unit.

A feature of a storage medium that stores a control program according to the present invention is that it is a storage medium storing control program that makes a computer operate as a terminal apparatus for controlling an enclosing/sealing system including a printing apparatus for performing printing on an object to be enclosed and an envelope in accordance with a printing job, and an enclosing/sealing apparatus for performing an enclosing/sealing process on the object to be enclosed and the envelope on which the printing apparatus has performed the printing, including successively generating, for each mail, enclosed object page data of one or a plurality of mails, generating envelope page data including a destination on the basis of destination information associated, for each mail, with the envelope page data of one or a plurality of mails, detecting separation data that represents separation for each mail arranged at a prescribed position in the enclosed object page data, sorting the enclosed object page data of one or a plurality of mails for each mail in accordance with the detected separation data, and associating each piece of enclosed object page data sorted for each mail with each piece of the generated envelope page data for each mail, and generating a printing job of one or a plurality of successive mails for each mail.

According to the first feature of the terminal apparatus of the present invention or the feature of a storage medium storing a control program of the present invention, separation for each mail of enclosed page data generated by an enclosed object data generation unit such as an existing document application or the like is detected, and pieces of the envelope page data are associated for each mail so as to generate envelope printing job data, and accordingly it is possible to associate envelopes and objects to be enclosed without error and at low cost while realizing printing of information on the objects to be enclosed and envelopes in an enclosing/sealing system.

According to the second feature of the terminal apparatus of the present invention, each piece of envelope page data is added to the top or the tail of the enclosed object page data separated for each mail, and thus positions of pieces of separation data and positions at which pieces of envelope page data are inserted coincide so that separation data also functions as data representing positions to which pieces of envelope page data have been added, making it possible to reduce the amount of information and simplify the control.

According to the third feature of the terminal apparatus of the present invention, destination information is detected from enclosed object page data, and envelope page data is generated from that destination information, and accordingly a more accurate association relationship can be obtained between envelopes and objects to be enclosed. Also, it is not necessary to store in a database destination information necessary for generating envelope page data, and thus the labor of storing destination information 36 in a database or the like can be eliminated.

### BRIEF DESCRIPTION OF DRAWINGS

FIG. 1 shows a configuration of an enclosing/sealing system according to an embodiment;

FIG. 2 is a block diagram showing the functions of an envelope editor in detail;

FIG. 3 shows an example of envelope page data generated by an envelope data generation unit;

FIG. 4A shows an outline of processes executed by respective constituents of the envelope editor (first);

FIG. 4B shows an outline of processes executed by respective constituents of the envelope editor (second);

FIG. 4C shows an outline of processes executed by respective constituents of the envelope editor (third);

FIG. 5A shows a method of setting separation data (first);

FIG. 5B shows a method of setting separation data (second);

FIG. 6 explains an association for each mail between document page data and envelope page data;

FIG. 7 shows an example of an input window for inputting print setting conditions; and

FIG. 8 is a flowchart showing a method of generating printing job data performed by the envelope editor.

### DESCRIPTION OF EMBODIMENTS

Hereinafter, detailed explanations will be given to the embodiments of the present invention by referring to the drawings.

### (Configuration of Enclosing/Sealing System)

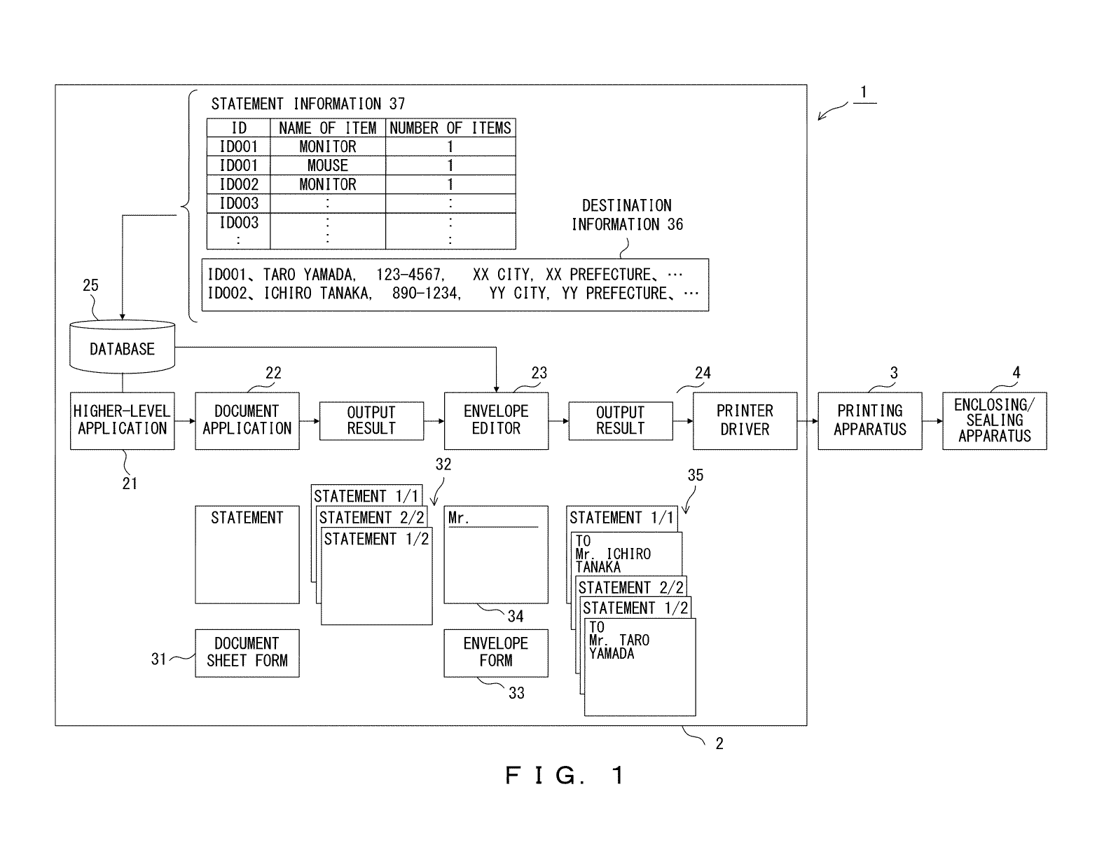

FIG. 1 shows a configuration of an enclosing/sealing system according to the present embodiment. In FIG. 1, the configuration of an enclosing/sealing system 1 and data input to/output from respective units are shown schematically.

The enclosing/sealing system according to the present embodiment includes, as shown in FIG. 1, a printing apparatus 3 for performing printing on an object to be enclosed and an envelop, an enclosing/sealing apparatus 4 for performing an enclosing/sealing process on the object to be enclosed and the envelope on which printing has been performed by the printing apparatus 3, and a terminal apparatus 2 such as a personal computer or the like for controlling the printing apparatus 3 and the enclosing/sealing apparatus 4.

In the present embodiment, the printing apparatus 3 performs printing on an object to be enclosed and an envelope in accordance with a printing job, and the enclosing/sealing apparatus 4 performs a enclosing/sealing process on an object to be enclosed and an envelop that have received the printing by the printing apparatus 3.

### (Configuration of Terminal Apparatus)

A terminal apparatus 2 is connected to the printing apparatus 3 and the enclosing/sealing apparatus 4. The terminal apparatus 2 transmits a printing job to the printing apparatus 3 side, and makes the printing apparatus 3 and the enclosing/sealing apparatus 4 execute a printing process and an enclosing/sealing process, respectively.

As an example of an object to be enclosed, there is a document. In the examples, “document” refers to a sheet that includes a data variable for each mail (destination) arranged in a prescribed form, that is enclosed in an envelope to be sealed, and that is sent to the destination, such as invoices, shipping slips, credit card statements, bank account balance statements of banking facilities, and the like. Documents may vary in the number of pages to be enclosed for each transmission set, and a known technique is used as a technique for recognizing the number of pages to be enclosed so as to perform enclosing and sealing. Hereinafter in the present embodiment, a case of “documents” is explained as an example of objects to be enclosed. Note that “enclosed document” or “document to be enclosed” also refers to an enclosed object or an object to be enclosed and enclosed content or content to be enclosed. Also, “document page data” also refers to enclosed object page data or data to be enclosed.

The terminal apparatus 2 has a higher-level application 21, a document application 22, an envelope editor 23, a printer driver 24, and a database 25. Also, the terminal apparatus 2 has an input unit (not shown) to which users input various information, a display unit (not shown) for displaying various information in accordance with the information input to the input unit, and memory (not shown) for storing various information.

The higher-level application 21 performs overall control on the database 25, the document application 22, and the envelope editor 23. The higher-level application 21 performs the following processes when it has received, via the input unit, an instruction to generate document page data 32 from a user, an instruction to generate envelope page data from a user, an instruction to generate printing job data in which document page data 32 to be enclosed and envelope page data 34 are associated, an instruction to perform printing by using printing job data, and enclosing/sealing.

In response to an instruction to generate the document page data 32 from a user, the higher-level application 21 inputs to the document application 22 variable data 36 held by the database 25, and instructs the document application 22 to generate the document page data 32 to the document application 22.

In response to an instruction to generate printing job data, the higher-level application 21 instructs the envelope editor 23 to generate the envelope page data 34 and to generate printing job data in accordance with the envelope page data 34 and the document page data 32 generated by the document application.

In response to an instruction of printing job data and an enclosing/sealing instruction, the higher-level application 21 instructs the printer driver 24 to perform an appropriate process in accordance with the print job generated by the envelope editor 23, to generate printing job data for printing, enclosing, and sealing, and to send the data to the printing apparatus 3.

The database 25 stores destination information 36 used for generating the envelope page data 34, and statement information 37 used for generating the document page data 32. The destination information 36 is described in the form of, for example, CSV, and has a record for each mail (set). Each record has ID information (such as ID001, etc.) for identifying the record, full name information representing the full name, and attribute information of address information (postal code, address, and the like) representing the destination address of a document. Similarly, the statement information 37 is described in the form of, for example, CSV, and includes one or a plurality of records for each mail. Each record includes ID information corresponding to the destination information 36, and statement content information (the names of items, the number of items, charged values, and the like in a case of, for example, a shipping slip).

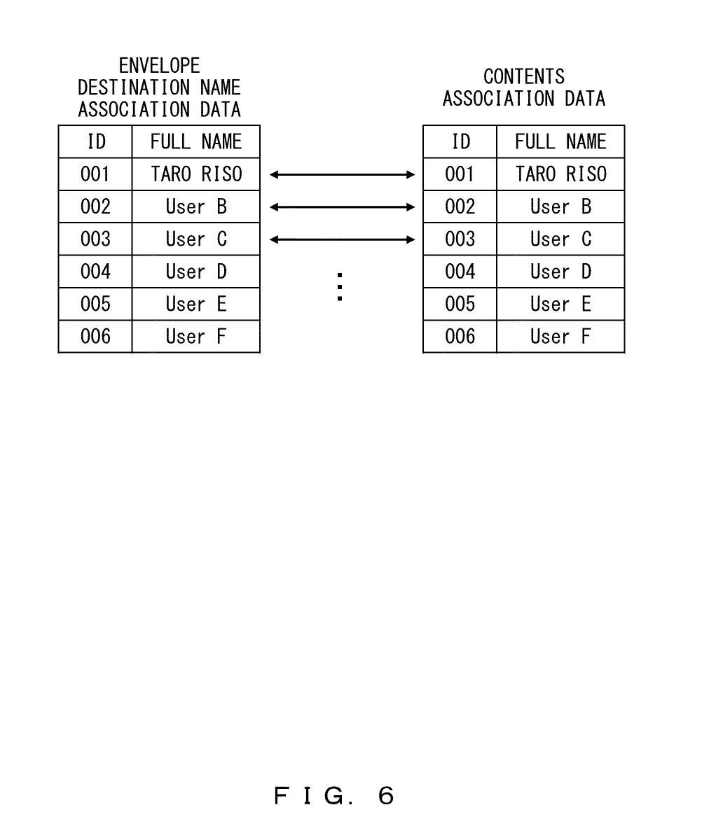

Also, in the database 25, envelope destination name association data in which ID information (information for identifying a client as a transmission destination) and full name information are associated for each piece of envelope page data 34, and content association data in which ID information and full name information are associated for each piece of document page data 32 are stored (see FIG. 6). In this example, envelope destination name association data and content association data are made of, for example, CSV data.

The document application 22 successively generates one or a plurality of mails of document page data 32 in accordance with an instruction from the higher-level application 21 for each mail. In this example, the document page data 32 is data in the format of, for example, PDF (Portable Document Format), or the like. The document page data 32 is made of one or a plurality of pieces of page data.

Specifically, the document application 22 holds form data for document sheets to be enclosed in envelopes (referred to as a document sheet form 31 hereinafter). This form is common for all destinations.

In accordance with an instruction from the higher-level application 21, the document application 22 generates the document page data 32 by arranging, at prescribed positions in the document sheet form 31, the statement information 37 and the destination information 36 among information input from the higher-level application 21.

The envelope editor 23 generates envelope page data 34, and generates a print job data in which one or a plurality of pieces of document page data 32 and the envelope page data 34 are associated for each destination (for each mail) on the basis of the document page data 32 generated by the document application 22 and the envelope page data 34, and outputs the generated print job data to the printer driver 24.

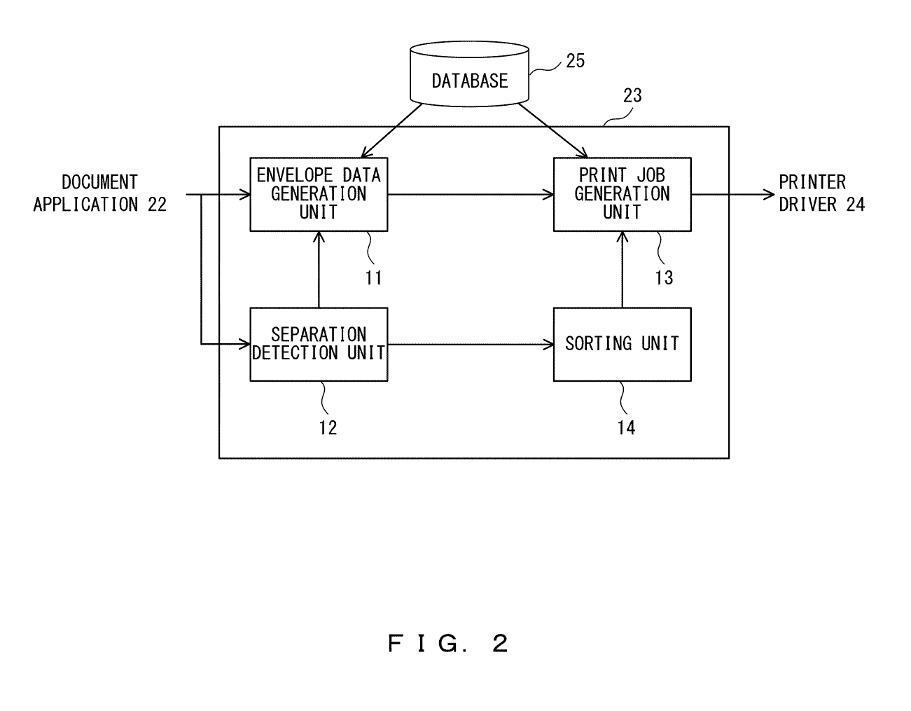

FIG. 2 is a block diagram showing the functions of the envelope editor 23 in detail. The envelope editor 23 generates printing job data in which the envelope page data 34 and the document page data 32 are associated for each mail on the basis of various information such as the destination information 36 or the like stored in the database 25 through inputting by users or displaying to users, the document page data 32 generated by the document application 22, and a common envelope form 33 that is retained.

The envelope editor 23 includes an envelope data generation unit 11, a separation detection unit 12, a sorting unit 14, and a print job generation unit 13.

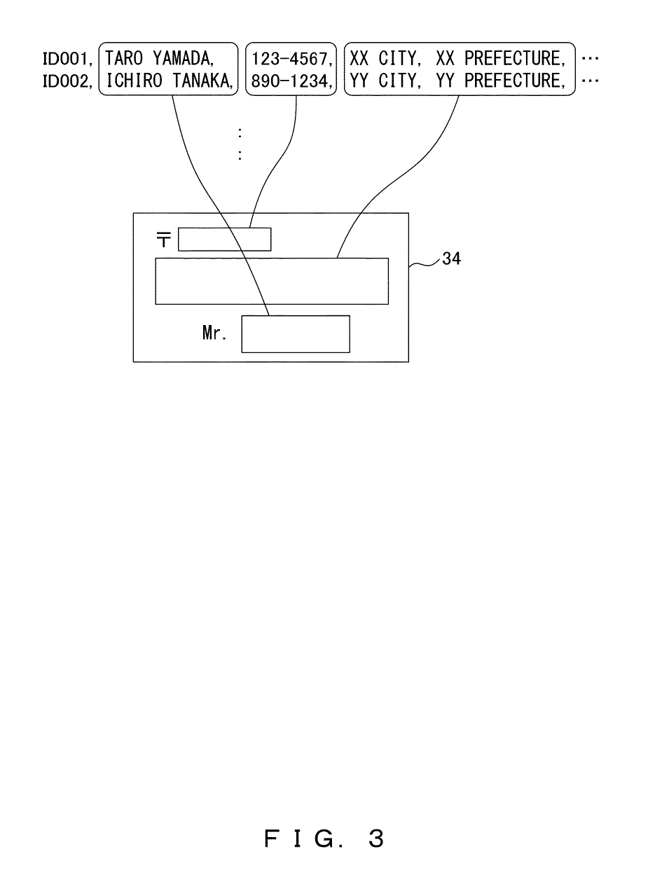

The envelope data generation unit 11 generates the envelope page data 34 including the destination on the basis of the destination information 36 associated with each mail of one or a plurality of mails of document page data 32. Specifically, the envelope data generation unit 11 uses, for example, the destination information 36 (full name information, address information (postal code and address)) and the envelope form 33 so as to generate the envelope page data 34 including destinations. In this example, an example of the envelope page data 34 generated by the envelope data generation unit 11 is shown in FIG. 3. In the envelope page data 34, among pieces of destination information 36, address information and full name information are arranged at prescribed positions, respectively.

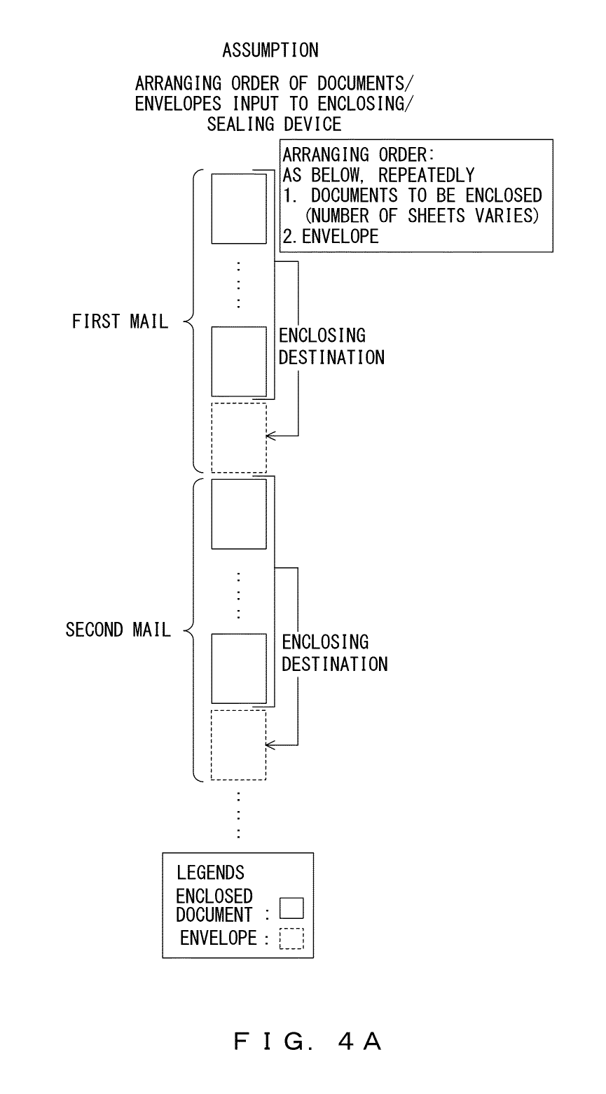

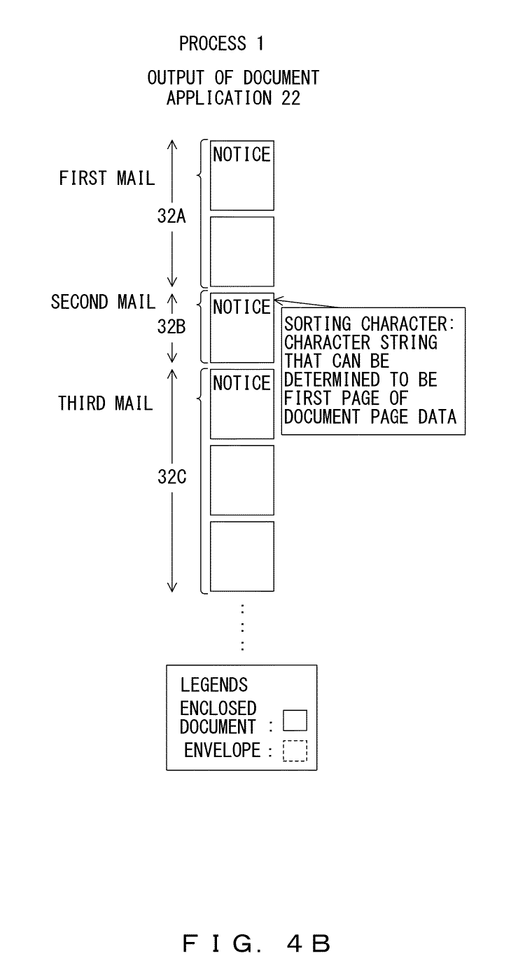

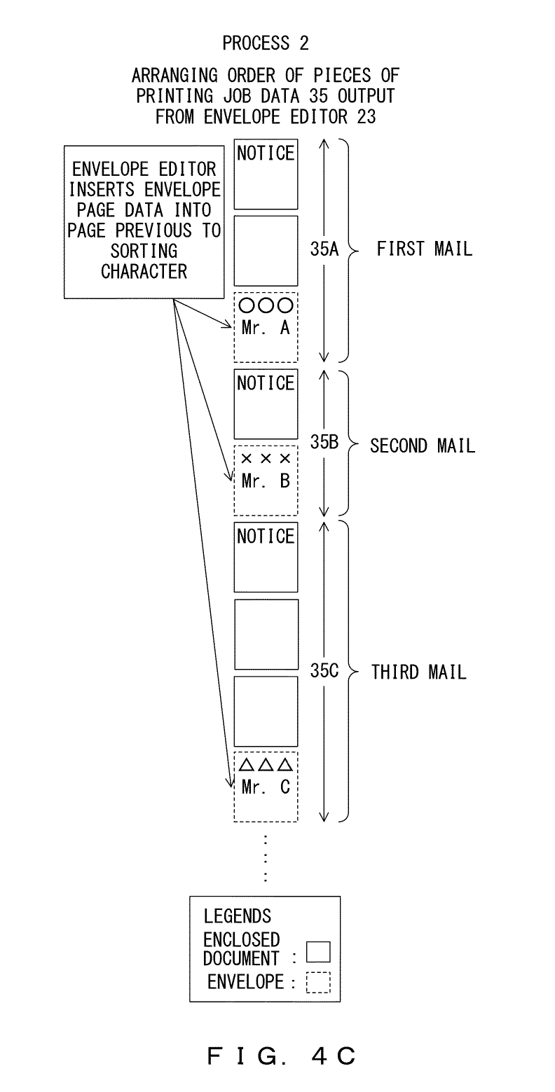

The separation detection unit 12 detects separation data, which represents separation for each mail arranged at prescribed positions in the document page data 32. The sorting unit 14 sorts one or a plurality of mails of document page data 32 for each mail on the basis of the separation data detected by the separation detection unit 12. The print job generation unit 13 associates the document page data 32 sorted by the sorting unit 14 for each mail with the envelope page data 34 for each mail generated by the envelope data generation unit 11, and generates one or a plurality of mails of printing job data that are successive for each transmission set. Detailed explanations will be given for specific operations of the separation detection unit 12, the sorting unit 14, and the print job generation unit 13 later by referring to FIGS. 4A, 4B and 4C, etc.

The printer driver 24 transmits to the printing apparatus 3 enclosing/sealing printing job data obtained by performing a necessary process on printing job data 35 that was generated by the envelope editor 23. Specifically, the printer driver 24 generates enclosing/sealing printing job data from the printing job data on the basis of print setting conditions or the like (the size of print sheets, or the like). This enclosing/sealing printing job data is, for example, PDL data.

Also, enclosing/sealing printing job data includes, for each mail, print instruction information that instructs in the printing of each piece of document page data 32 and the associated piece of envelope page data 34 by using a printing apparatus, and enclosing/sealing instruction information that instructs the enclosing/sealing apparatus 4 to perform an enclosing and sealing process of an enclosed document printed by the printing apparatus 3 (an object obtained by printing information on a print sheet in accordance with the document page data 32) and an envelope (an object obtained by printing information on a print sheet in accordance with the envelope page data 34).

Input operations of print setting conditions such as size, orientation, and the like of the document page data 32 and the envelope page data 34 will be explained later in detail by using specific input windows.

### (Configurations of Printing Apparatus and Enclosing/Sealing Apparatus)

When the printing apparatus 3 has received enclosing/sealing printing job data from the terminal apparatus 2 side, it performs a printing process on a document to be enclosed and a printing process on an envelope on the basis of, for example, the result of a RIP process. The printing apparatus 3 transmits the document to be enclosed and the envelope to the enclosing/sealing apparatus, and also transmits enclosing/sealing instruction information to the enclosing/sealing apparatus. The enclosing/sealing apparatus 4 performs an enclosing/sealing process on the basis of the document to be enclosed and the envelope transmitted from the printing apparatus 3.

### (Processes of Document Application and Envelope Editor Related to the Generation of Printing Job Data)

Next, the processes of the document application and the envelope editor related to the generation of printing job data will be explained in detail by referring to FIGS. 4A, 4B and 4C.

FIGS. 4A, 4B and 4C explain the outline of a process executed by each constituent of the terminal apparatus 2 (particularly the document application and the envelope editor) before the generation of the printing job data 35. In this example, a case is explained in which each piece of the envelope page data 34 is inserted after the tail of the corresponding piece of the document page data 32 so as to generate printing job data as an example.

FIG. 4A shows the arranging order of envelopes and enclosed documents to be input to the enclosing/sealing apparatus 4. First, the envelope editor 23 holds the arranging order of enclosed documents and envelopes to be input to the enclosing/sealing apparatus 4 as shown in FIG. 4A. This arranging order is transmitted to the envelope editor 23 when, for example, a user has input the arranging order of pieces of printing job data by using an input unit. In FIG. 4A, enclosed documents are drawn by solid lines while envelopes are drawn by dashed lines.

First, a process of generating document page data 32 (process 1) is performed by the document application 22. FIG. 4B shows a process of generating the document page data 32 performed by the document application 22. The document application 22 generates the document page data 32 with pieces of the document page data 32A through 32C being arranged successively for each of the plurality of destinations (for each of destination A, destination B, and destination C). The generated pieces of the document page data 32A through 32C are input to the envelope editor 23. The document page data 32 is generated by arranging various types of attribute information of the destination information 36 at prescribed positions on the common document sheet form 31.

Next, the envelope editor 23 performs a process of generating printing job data (process 2). FIG. 4C shows the generation of printing job data performed by the envelope editor 23.

Usually, the number of pieces of page data and the number of sheets of documents to be enclosed in one envelope varies depending upon destination. Accordingly, the envelope editor 23 has to discriminate between the document page data 32 of a destination (one mail) and the document page data 32 of the next destination (another mail) when the envelope page data 34 is to be inserted into a plurality of successive pieces of document page data 32. In the explanation of the present embodiment, separating, in units of transmission sets, a group of pieces of the document page data 32 in a plurality of successive pieces of document page data 32 is referred to as “sorting”.

The sorting unit 14 of the envelope editor 23 detects a prescribed character string or the like printed at a prescribed position on the common document sheet form 31 so as to perform a sorting process.

As a specific example, the sorting unit 14 of the envelope editor 23 determines the first piece of the document page data 32 among one or a plurality of pieces of the document page data 32 in units of transmission sets on the basis of whether or not there is judged to be a “Notice” character string at a prescribed position on the common document sheet form in the document page data 32.

As explained by referring to FIG. 2, the sorting unit 14 of the envelope editor 23 performs the above sorting process on the basis of separation data, which represents separation for each mail detected by the separation detection unit 12 from the document page data 32. In the example shown in FIGS. 4A, 4B and 4C, sorting is performed on the basis of the “Notice” character string arranged at a prescribed position in the document page data 32.

Hereinafter, information such as a prescribed character string arranged at a prescribed position in the document page data 32 used for sorting is referred to as “separation data”. It is necessary to set separation data and the position at which the separation data is arranged before the envelope editor 23 executes a sorting process. In this example, explanations will be given for a case where a prescribed character string (for example, “Notice”) arranged at a prescribed position in the common document sheet form 31 is set as separation data, and the envelope page data 34 is arranged at the tail of the document page data 32 of each mail. Detailed explanations will be given later for a method of setting separation data.

The sorting unit 14 determines the first piece or the last piece of the document page data 32 for a destination (mail) on the basis of a detected character string or the like, and recognizes a separation of the document page data 32 for each transmission set (execute “sorting process”). Each piece of document page data 32 after being sorted is transmitted to the envelope editor 23.

The envelope editor 23 inserts the corresponding envelope page data 34 before the first piece of the document page data 32 in which a prescribed character string is arranged at a prescribed position in each piece of the document page data 32 (for example, before the document page data 32 in which “Notice” of FIG. 4(b) is arranged at a prescribed position) on the basis of the arranging order of the documents to be enclosed and envelopes input to the enclosing/sealing apparatus 4 as shown in FIG. 4(a). Note that association of the document page data 32 and envelopes for each transmission set will be explained later.

The envelope editor 23 transmits printing job data 35A through 35C to the printer driver 24. Thereafter, the printer driver 24 transmits enclosing/sealing printing job data to the printing apparatus 3. The printing apparatus 3 performs printing processes in the order in which the pieces of data were input, and transmits printed documents/envelope to the enclosing/sealing apparatus 4.

### (Separation Data Setting Process)

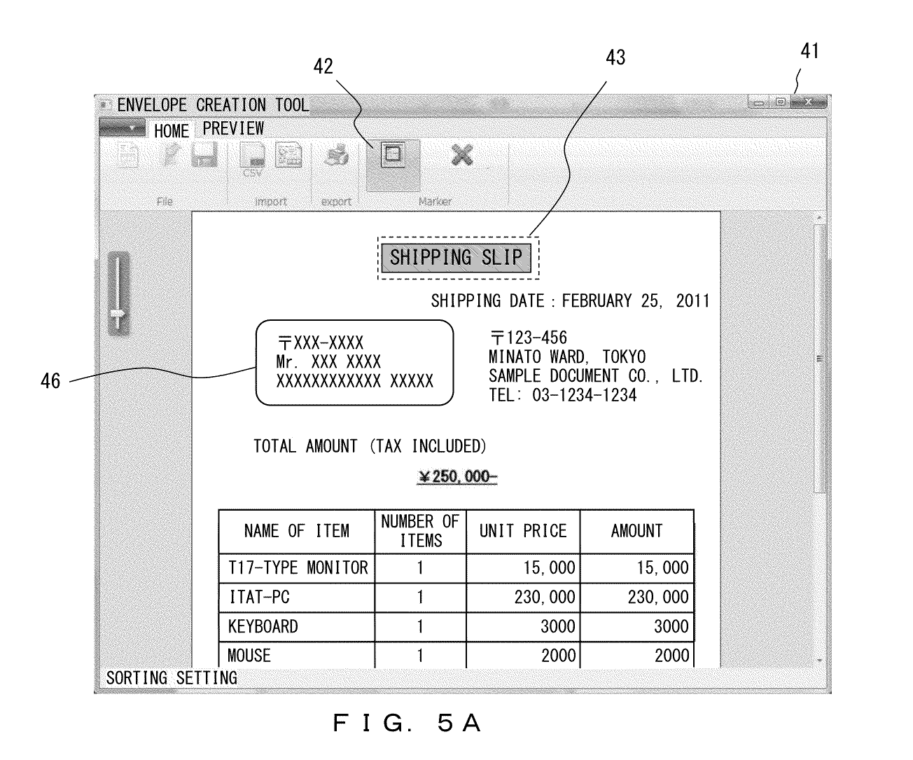

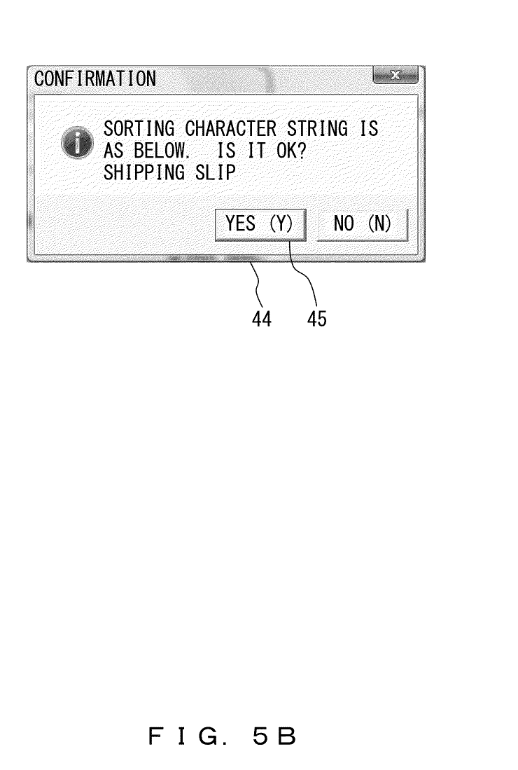

FIGS. 5A and 5B show a process of setting separation data. FIG. 5A shows an example of a display window for inputting a fact that separation data is set through the input unit. When a user has input, through the input unit, a fact that he or she is going to activate the envelope editor 23, a program of the envelope editor 23 is activated, and a window 41 is displayed. When the user presses a button 42 of “Setting of sorting” after specifying separation data by using the input unit, the setting of separation data is performed.

In order to prompt users to specify apiece of separation data, the envelope editor 23 makes the display window display sample data of the document page data 32 for specifying a piece of separation data. As this sample data, there are, for example, data in which the document title, the destination information 36, and the statement information 37 are arranged on the common document sheet form 31, and data in which the statement information 37 is arranged on the common document sheet form 31.

A user specifies, among the above sample data, an area in which the separation data is to be arranged. In this example, explanations will be given for an exemplary case where an area 43 (an area in which separation data is arranged) including a character string “Shipping slip” (separation data) is specified.

When a user has specified an area that he or she wants to be set as separation data, the envelope editor 23 makes the display unit display a dialog box 44 displaying a message confirming separation data and an area in which the separation data is arranged as shown in FIG. 5B.

When the user has pressed a button 45 of “Yes(Y)”, the envelope editor 23 stores in a memory device the separation data (character string in the area 43) and information representing the area in which the separation data is arranged (positional coordinates to determine the specified area 43), which will be referred to as “separation data arrangement area information” hereinafter.

By performing a separation data setting process as described above, when the document page data 32 is input from the document application 22, the envelope editor 23 can extract separation data and separation data arrangement area information from the memory device so as to search for separation data such as a prescribed character string or the like on the basis of the extracted data. Also, when a search is conducted for separation data, it is possible to determine the first and last piece of the document page data 32 associated with a transmission set.

### (Association Process Between the Document Page Data 32 and Envelope for Each Mail)

FIG. 6 explains an association between the document page data 32 and the envelope page data 34 for each mail. In order to perform an enclosing/sealing process appropriately for each transmission set in the enclosing/sealing apparatus 4, a document and an envelope has to be associated for each transmission set so as to be input to the enclosing/sealing apparatus 4 as a pair.

The envelope editor 23 obtains from the database 25 envelope destination name association data and content association data. In the envelope editor 23, the print job generation unit 13 refers to envelope destination name association data for the envelope page data 34 generated for each mail by the envelope data generation unit 11, and assigns pieces of ID information to respective pieces of envelope page data 34 (refer to, for example, FIG. 4(a)). Also, in the envelope editor 23, the print job generation unit 13 refers to the content association data so as to assign ID information to the respective pieces of document page data 32 that were sorted by the sorting unit 14. When, for example, pieces of document page data have been sorted to document page data 1-2 (sorting 1), document page data 3 (sorting 2), and document page data 4-6 (sorting 6), the print job generation unit 13 assigns 001 through 003 to the respective pieces of document page data of sorting 1 through 3. This ID information is associated with a mail.

The print job generation unit 13 refers to the arranging order of envelopes and documents to be enclosed that is to be input to the printing apparatus 3, and arranges, in accordance with the page data order, each piece of the document page data 32 that is associated with ID information (001) and that was sorted first, and arranges (inserts) the piece of the envelope page data 34 associated with ID information (001) before each piece of the document page data 32 that is associated with ID information (002) and that was sorted next. Thereafter, the print job generation unit 13 arranges, at the tail of the above envelope page data 34, each piece of document page data 32 that is associated with ID information (002) and that was sorted next, and repeats this process so that the print job generation unit 13 generates printing job data in which each piece of document page data 32 and the envelope page data 34 are associated for each mail.

As described above, association between documents and envelopes is performed appropriately in accordance with the ID list in FIG. 6. Specifically, as shown in FIG. 4(c), pieces of printing job data 35A through 35C in which the document page data 32 and the envelope page data 34 having identical IDs are associated can be generated, such as in a case where the document page data 32 and the envelope page data 34 both having ID=001 are associated, or the document page data 32 and the envelope page data 34 both having ID=002 are associated, etc.

### (Input Process of Print Setting Condition)

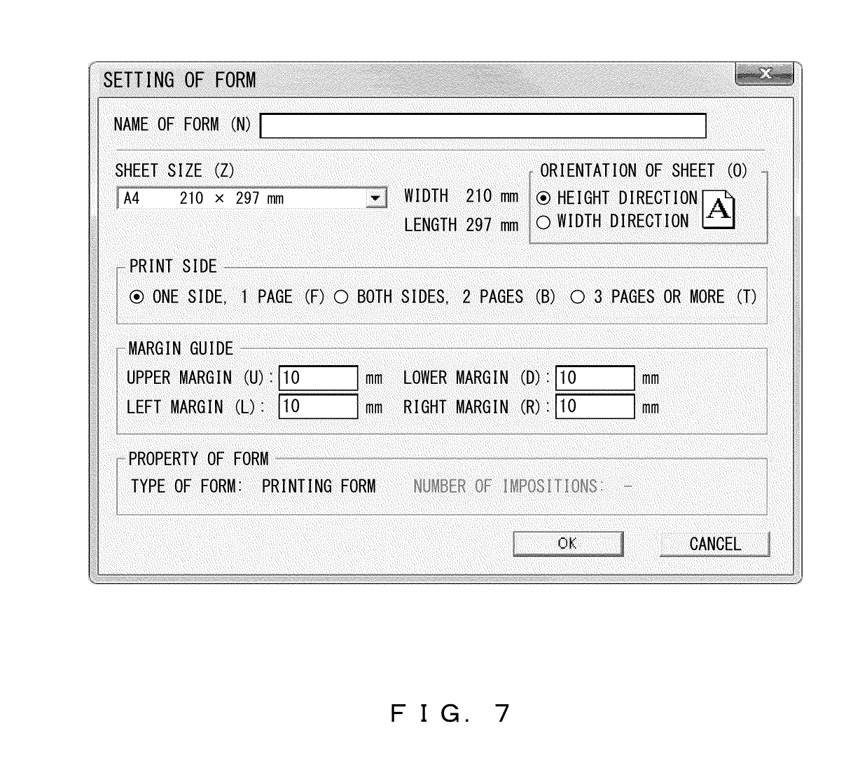

FIG. 7 shows a window for inputting print setting conditions such as the size, the orientation, and the like of the document page data 32 and the envelope page data 34. In this example, explanations are given for an exemplary case of the document page data 32. However, the same explanations can be applied to the case of the envelope page data 34.

When, for example, the envelope editor 23 has generated printing job data in which the document page data 32 and the envelope page data 34 are associated for each mail, that fact is displayed on the display unit via the higher-level application 21.

When a user has issued a print instruction by using the input unit, printing job data which was generated by the envelope editor 23 and in which the document page data 32 and the envelope page data 34 are associated for each mail is transmitted to the printer driver 24, in accordance with an instruction from the higher-level application 21, and a window for setting various printing conditions is displayed. In FIG. 7, as an example, a window for setting the sheet size, the orientation, and the like of a document is shown.

Information input by the user through the window by using the input unit is transmitted to the printer driver 24. The printer driver 24 performs, in accordance with the transmitted information, a setting process about the size or the like on the envelope page data 34 and the document page data 32 for each mail, and generates enclosing/sealing printing job data. The printer driver 24 transmits the generated enclosing/sealing printing job data to the printing apparatus 3.

### (Method of Generating Printing Job Data)

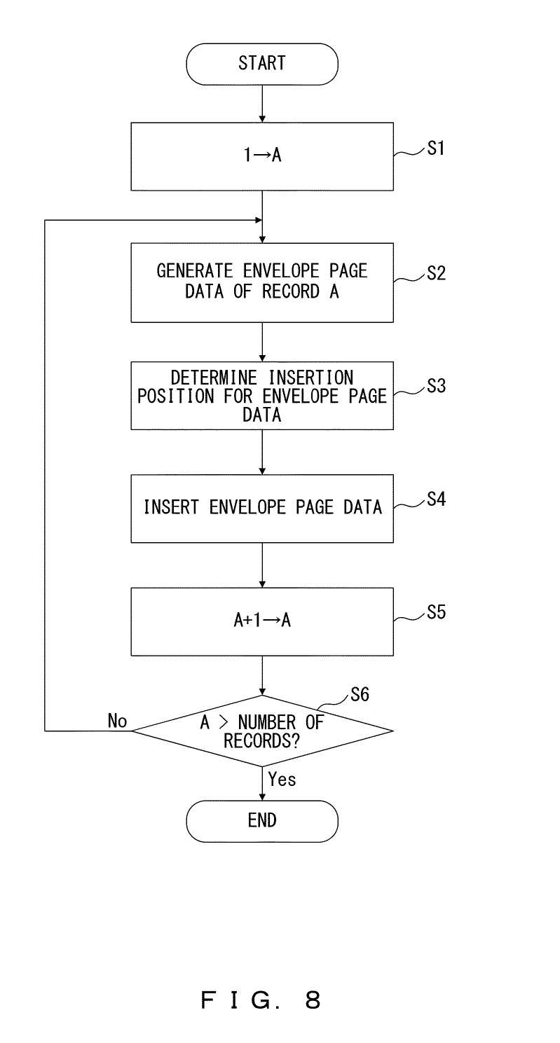

FIG. 8 is a flowchart explaining a method of generating printing job data performed by the envelope editor 23. When the document page data 32 generated by the document application 22 is input to the envelope editor 23, the following processes are executed in the envelope editor 23.

First, it is reported to the envelope data generation unit 11 that the document page data 32 has been generated by the document application 22. In Parallel to this reporting, the document page data 32 generated by the document application 22 is transmitted to the separation detection unit 12.

The envelope data generation unit 11 initializes counter A held by the envelope data generation unit 11, and sets “1” (step 1). Counter A counts the number of mails in the printing job data.

The envelope data generation unit 11 accesses the database 25, and refers to the number of IDs in the destination information 36 so as to obtain the total number of records in the destination information 36.

Thereafter, the envelope data generation unit 11 obtains each piece of information (full name information and address information) of the first record, and arranges the above each piece of information at prescribed positions in the envelope form data held by itself so as to generate the envelope page data 34 (step 2). The generated envelope page data 34 is transmitted to the print job generation unit 13.

When the separation detection unit 12 has detected separation data of a plurality of successive pieces of the document page data 32 and the arrangement areas of the separation data as described above, the separation detection unit 12 transmits these pieces of data to the sorting unit 14.

The sorting unit 14 determines a group for each mail in the document page data 32 on the basis of the separation data and the data arrangement area information detected by the separation detection unit 12 (sorting process, step 3). A group for each mail in the document page data 32 is transmitted to the print job generation unit 13 by the sorting unit.

Also, the print job generation unit 13 obtains the envelope destination name association data and the content association data from the database 25. The print job generation unit 13 refers to the envelope destination name association data and the content association data so as to recognize the association relationship between the transmitted envelope page data 34 and the document page data 32.

The print job generation unit 13 determines the position to which the envelope page data 34 is inserted in the document page data 32 on the basis of a group for each mail transmitted from the sorting unit 14, and inserts the associated piece of envelope page data 34 at the tail of the document page data 32 for each transmission set (step 4). And the print job generation unit 13 increments the value of counter A by one (step 5).

The print job generation unit 13 determines whether or not the value of counter A has exceeded the total number of records (step 6). When the value of counter A has exceeded the total number of records (Yes in step 6), the process is terminated. When the value of counter A is equal to or smaller than the total number of records, the process returns to step 2, and the same operations are repeated.

When this process is terminated, the print job generation unit 13 generates printing job data in which the associated piece of envelope page data 34 has been inserted at the tail of the last piece of the document page data 32 for each mail.

(Function Effects)

As described above, according to the enclosing/sealing system 1 of the present embodiment, the separation detection unit 12 detects separation data, which represents separation for each transmission set of the document page data 32 for the document page data 32 input to the envelope editor 23. The sorting unit 14 sorts pieces of document page data 32 in accordance with the detected separation data so that the document page data 32 consisting of one or a plurality of mails are distinguished in units of groups of destinations (mails). The print job generation unit 13 associates the document page data 32 sorted by the sorting unit 14 with the envelope page data 34 generated by the envelope data generation unit 11 for each mail in order to generate printing job data for one or a plurality of mails. The printing process and the enclosing/sealing process are performed in accordance with the generated printing job data.

As a result of this, even when the document application 22 only has the function of generating the document page data 32 as in conventional techniques, users do not have to perform setting in regard to association between the document page data 32 and the envelope page data 34, the envelope editor 23 can generate the envelope page data 34 in which the destination information 36 is arranged, and can also generate printing job data in which the document page data 32 and the envelope page data 34 are associated.

Accordingly, it is possible to associate enclosed object data generated by the existing document application 22 with the envelope page data 34 so as to generate print jobs for performing a printing process and an enclosing/sealing process at a low cost.

Also, even when, for example, the document application 22 does not support a process of printing a destination name, the envelope editor 23 can print destination names on envelopes without using envelopes having windows. By avoiding the use of envelopes having windows, printing costs can also be reduced.

Also, in the present embodiment, separation data is set at the top or the tail of the document page data 32 in units of mails, and the associated piece of envelope page data 34 is inserted at the top and the tail of pieces of the document page data 32 separated for each transmission set by the sorting process, and thereby printing job data is generated.

Even when, for example, the associated piece of envelope page data 34 is inserted into the page data at the middle of respective pieces of document page data 32 for each transmission set, it is possible to generate printing job data in which the document page data 32 and the envelope page data 34 are associated for each destination. However, in this case, the envelope page data 34 is arranged at a different position from the position of separation for successive pieces of the document page data 32. Accordingly, a process has to be conducted to store the relationship between the position of separation data and the position of the envelope page data 34, increasing the amount of information for associating the document page data 32 with the envelope page data 34. This also makes the control complicated.

In the present embodiment, the position of separation data and the position at which the envelope page data 34 is inserted coincide, and the separation data also functions as data that represents the insertion position for the envelope page data 34, and accordingly it is possible to reduce the information amount and to simplify the control because the above situation does not occur.

It is also possible to insert the associated piece of envelope page data 34 at a position (for example, the center) that is not the tail or the top of each piece of page data of the terminal apparatus 2 for each transmission set so as to generate printing job data in which the document page data 32 and the envelope page data 34 are associated for each transmission set, although this configuration is worse than the above configuration in information amount reduction and control simplification.

### (Variation Example of Process of Generating Envelope Page Data 34)

It is also possible for the envelope data generation unit 11 to have a destination data detection function for detecting the destination information 36 associated with each mail from the document page data 32 so as to generate the envelope page data 34 by using envelope form data and the detected destination data.

In the above embodiment, the envelope data generation unit 11 extracts various types of attribute information of the destination information 36 or the like from the database 25, and arranges the extracted information in the envelope form 33. However, the scope of the present invention is not limited to this example, and it is also possible to use the document page data 32 to generate the envelope page data 34.

When the arrangement area for the destination data is specified using the same method as explained in the case where separation data and data arrangement area are specified among pieces of sample data of the document page data 32, information representing the arrangement area for destination data is stored in the memory device.

In this example, explanations will be given for a case where the document page data 32 having separation data arranged therein includes destination data. When the document page data 32 has been input from the document application 22, the separation detection unit 12 detects the document page data 32 in which separation data has been arranged. Then, the envelope data generation unit 11 extracts information representing the arrangement area of the destination data from the memory device, and searches for destination data existing in the arrangement area of the destination data among pieces of the document page data 32 detected by the separation detection unit 12.

The envelope data generation unit 11 arranges the detected destination data in the area in which the destination information 36 of the envelope form data is to be arranged so as to generate the envelope page data 34.

It is also possible to store in the memory device a position relative to the position at which the separation data is arranged instead of information representing the arrangement area of the destination data. It is also possible to perform a process of detecting destination data parallelly to the process of detecting separation data.

According to the present variation example, association relationships between envelopes and objects to be enclosed for generating the envelope page data 34 can be made more accurate because the destination information 36 and the envelope form data associated for each mail are used. Also, it is not necessary to store in the database 25 the destination information 36 necessary for generating the envelope page data 34, which makes it possible to eliminate the labor of storing the destination information 36 in the database 25.

### (Different Variation Example)

The printing apparatus 3 and the enclosing/sealing apparatus 4 may be independent apparatuses as shown in FIG. 1, and may also be implemented as a single apparatus that can execute a printing process and an enclosing/sealing process.

In the embodiments described above, explanations have been given for a case where the statement information 37 associated with the destination information 36 is used so as to generate the envelope page data 34, the document page data 32, and the enclosing/sealing printing job data, and thereafter the printing process and the enclosing/sealing process are executed. However, the scope of the present invention is not limited to this example, and it is also possible to temporarily store the envelope page data 34 and the document page data 32 that have been generated in the database 25 so as to use them to execute a printing process and an enclosing/sealing process.

Explanations were given for a case where the printer driver 24 generates printing job data for enclosing/sealing on the basis of printing job data generated by the envelope editor 23. However, it is also possible to employ a configuration in which the envelope editor 23 has the function of the printer driver 24 so as to generate printing job data for enclosing/sealing.

Also, explanations were given by using an example in which the character string “shipping slip” is set as separation data in FIG. 6. However, separation data is not limited to a character string. It is also possible to employ a configuration of setting various symbols, codes, images such as icons, etc. in addition to character strings.

Also, in the above embodiment, explanations were given for a case where sample data of each piece of the document page data 32 is held beforehand by the envelope editor 23. However, the scope of the present invention is not limited to this example, and the envelope editor 23 may read each piece of the document page data 32 so as to extract the above sample data.

Also, in the above embodiment, explanations were given for a case where envelope destination name association data and content association data were stored beforehand in the database 25. However, the scope of the present invention is not limited to this example. For example, it is also possible to employ a configuration in which a user generates envelope destination name association data and content association data via the higher-level application 21 so as to store them in the database 25. It is also possible to employ a configuration in which a user modifies envelope destination name association data and content association data stored in the database 25 via the higher-level application 21.

Although explanations were given for a case where an instruction to generate the document page data 32 from a user, an instruction to generate printing job data in which the document page data 32 and the envelope page data 34 are associated, an instruction to print printing job data, and an enclosing/sealing instruction are received by the higher-level application 21 via the input unit in the above embodiment, it is also possible for the higher-level application 21 to issue an instruction to generate the document page data 32, an instruction to generate and print printing job data, and an instruction to perform an enclosing/sealing system when a preview instruction or an instruction to print printing job data are input from a user.

Also, the envelope data generation unit 11 may perform a process of obtaining all records in step 1 in FIG. 8 by referring to the number of IDs in envelope destination name association data and content association data that are not involving variable data.

Although explanations were given for a case where, when the printer driver 24 has transmitted printing job data for enclosing/sealing to the printing apparatus 3, the printing apparatus 3 executes the printing process, the result of the process is transmitted to the printing apparatus 3, and the enclosing/sealing apparatus 4 executes an enclosing/sealing process, it is also possible to employ a configuration in which the printer driver 24 transmits printing job data for enclosing/sealing to the printing apparatus 3, and also issues an instruction to execute an enclosing/sealing process on an object (envelope or document to be enclosed) transmitted from the printing apparatus 3.

In the above embodiment, explanations were given for a case where the higher-level application 21 entirely controls the respective units. However, the scope of the present invention is not limited to this. For example, the higher-level application 21 maybe deleted in the terminal apparatus 2. Then, the document application 22 and the envelope editor 23 are activated through an input unit. Then, a user may use the document application 22 to generate the document page data 32 through the input unit. Then, the user activates the envelope editor 23 through the input unit so as to generate the envelope page data 34 so that the document page data 32 generated by the document application is read in order to generate printing job data.

Explanations were given on the assumption that the enclosing/sealing system 1 is used for printing information on documents and for printing destinations of the documents. However, the scope of the present invention is not limited to this. The present invention can be applied similarly to objects to be enclosed that are not a document (form). It is also possible for the printing apparatus 3 side to have the function of the terminal apparatus 2.

In addition to the above, various modifications and alterations may be allowed without departing from the spirit of the present invention. For example, it is possible to omit one or a plurality of constituents from the entire configuration described in the above embodiments, and also to combine different constituents appropriately.

1. A terminal apparatus that controls an enclosing/sealing system comprising a printing apparatus for performing printing on an object to be enclosed and an envelope in accordance with a print job, and an enclosing/sealing apparatus for performing an enclosing/sealing process on the object to be enclosed and the envelope on which the printing apparatus has performed the printing, the terminal apparatus comprising:
an enclosed object data generation unit configured to successively generate, for each mail, enclosed object page data of one or a plurality of mails;
an envelope page data generation unit configured to generate envelope page data including a destination on the basis of destination information associated, for each mail, with the envelope page data of one or a plurality of mails;
a separation detection unit configured to detect separation data that represents separation for each mail arranged at a prescribed position in the enclosed object page data;
a sorting unit configured to sort the enclosed object page data of one or a plurality of mails for each mail in accordance with the separation data detected by the separation detection unit; and
a print job generation unit configured to associate each piece of page data sorted by the sorting unit for each mail with each piece of envelope page data for each mail generated by the envelope page data generation unit, and to generate a print job of one or a plurality of successive mails for each mail.

2. The terminal apparatus according to claim 1, wherein:
the separation data is arranged at a top or a tail of each mail of the page data; and
the print job generation unit adds the each piece of envelope page data to a top or a tail of the enclosed object page data of one or a plurality of mails sorted by the sorting unit for each mail so as to perform association for each mail, and generates the print job of one or a plurality of mails.

3. The terminal apparatus according to claim 1, further comprising:
a destination information detection unit configured to detect destination information associated with each mail from the enclosed object page data of one or a plurality of mails, wherein:
the envelope page data generation unit generates the envelope page data by using prescribed envelope form data and the destination information detected by the destination information detection unit.

4. A storage medium storing control program that makes a computer operate as a terminal apparatus for controlling an enclosing/sealing system comprising a printing apparatus for performing printing on an object to be enclosed and an envelope in accordance with a print job, and an enclosing/sealing apparatus for performing an enclosing/sealing process on the object to be enclosed and the envelope on which the printing apparatus has performed the printing, comprising:
successively generating, for each mail, enclosed object page data of one or a plurality of mails;
generating envelope page data including a destination on the basis of destination information associated, for each mail, with the envelope page data of one or a plurality of mails;
detecting separation data that represents separation for each mail arranged at a prescribed position in the enclosed object page data;
sorting the enclosed object page data of one or a plurality of mails for each mail in accordance with the detected separation data; and
associating each piece of enclosed object page data sorted for each mail with each piece of the generated envelope page data for each mail, and generating a print job of one or a plurality of successive mails for each mail.
